(19) United States
(12) Patent Application Publication
(10) Pub. No.: US 2022/0366460 A1
(43) Pub. Date: Nov. 17, 2022

(54) MULTI-CHANNEL COMMUNICATION ANALYSIS AND PERFORMANCE

(71) Applicant: State Farm Mutual Automobile Insurance Company, Bloomington, IL (US)

(72) Inventors: Ryan Hobart, Bloomington, IL (US); Chris Cloyd, Bloomington, IL (US); Satya Ravinuthala, Normal, IL (US)

(21) Appl. No.: 17/744,116

(22) Filed: May 13, 2022

Related U.S. Application Data
(60) Provisional application No. 63/189,523, filed on May 17, 2021.

(51) Int. Cl. G06Q 30/02; H04L 51/216

(52) U.S. Cl. CPC G06Q 30/0281; H04L 51/216

(57) ABSTRACT

Techniques described herein relate to determining associations between different interactive communication sessions performed between users and an organization, over multiple different communication channels. A multi-channel analysis system may receive and compare user data from communication records captured via different communication channel systems, such as phone systems, web servers, chat systems, etc. In some examples, the multi-channel analysis system may determine confidence levels for associations between different communication sessions, based on matches between different user data fields and/or other attributes of the communication sessions. Individual communication sessions may be associated with communication initiators and/or communication results, and the multi-channel analysis system may use associations between communication sessions and confidence levels to determine and update performance metrics associated with communication initiators and/or communication results.

### RELATED APPLICATIONS

This application claims priority to and is a non-provisional of U.S. Patent Application No. 63/189,523, filed May 17, 2021, and entitled “MULTI-CHANNEL COMMUNICATION ANALYSIS AND PERFORMANCE,” the disclosure of which is incorporated by reference herein in its entirety for all purposes.

### BACKGROUND

Large organizations often use contact centers and other multi-channel communication systems to support interactions with customers of the organization or other users. Businesses, government agencies, educational institutions, and other types of organizations may implement telephone-based systems, video-based systems, web-based systems, chat/instant messaging systems, and/or various other interactive communication systems to provide user service and support. Organizations may use their various interactive communication systems to provide different types of customer support and services, such as sales, account services, technical support, problem resolution, and the like. Within such communication systems, different communication channel types (e.g., phone, video, chat, web-based, etc.) may be implemented as separate and disparate systems, and/or may be integrated within a single multi-channel contact center.

The various hardware, network, and software components of a communication system may support interactive communication sessions between users and organization representatives, each operating independently on separate computing devices. Different communication systems may support different combinations of interactive communication session types and/or media types, including voice sessions (e.g., telephony-based), video chat sessions, email communications, social media-based sessions, etc. When an interactive communication session with a user is requested and initiated, the communication system may capture data related to the user and/or the user's device, such as phone numbers of incoming calls, IP/network addresses of requesting devices, or URLs or link identifiers for sessions initiated by users clicking on web links. During interactive sessions, communication systems also may capture additional user information, such as names, account numbers, physical addresses, and the like, based on interactions with the user.

When individual users or groups of associated users engage in communication sessions with an organization, often multiple different communication sessions may be used to perform a task or achieve result. In these cases, it can be useful for the organization to determine when different communication sessions are linked or related to the same task or result. As an example, a user may engage in multiple different communication sessions with the communication system(s) of an insurance company to submit a policy application. First, the user may call a corporate number or local agent to inquire about a policy before receiving a quote, then the user may browse the company's web site after clicking an online ad to gather additional information, then the user may access the insurance company's online quote system with their computer to receive a quote a submit an application. For the insurance company in this example, or for other types of organizations in other examples, it can be valuable to determine when different communication sessions are linked or related. Communication sessions that are linked or associated with a single customer task or result may be analyzed to assess the value of different marketing efforts, and/or to improve organizational efficiency and streamline the customer's journey to complete the task or result.

Some organizations attempt to link different communication sessions by providing reference numbers (e.g., customer account numbers, help ticket numbers, etc.) that a customer may use to expedite future communications that are related to the same issue. However, such reference numbers shift the burden of tracking to the customer and also delay communication sessions by requiring the customer to retrieve and recite their reference number. Existing systems also attempt to identify related communication sessions by matching customer contact data, such as grouping calls received from the same phone number, or messages received from the same email address, etc. However, such systems may fail to determine related communication sessions that are performed over different communication channels (e.g., a phone call and a related web chat session). Additionally, matching communication sessions based on customer contact data may fail to accurately identify communication sessions that are related to the same task or result. For instance, conventional systems that match customer phone numbers, email addresses, physical addresses, etc., may erroneously conclude that a first communication session to request a quote or make a purchase is related to a second communication session to update customer information or resolve technical support issue. Similarly, conventional systems based on matching customer contact data may separate related communication sessions that are performed by different customers and/or using different client devices, and may erroneously conclude that related communication sessions are unrelated.

### SUMMARY

To address these and other problems and inefficiencies, this disclosure describes systems and techniques for determining associations between different interactive communication sessions performed between users and an organization, over multiple different communication channels. A multi-channel analysis system may receive and compare user data from communication records captured via different communication channel systems, such as phone systems, web servers, chat systems, etc. In some examples, the multi-channel analysis system may determine confidence levels for associations between different communication sessions, based on matches between different user data fields and/or other attributes of the communication sessions. Individual communication sessions may be associated with communication initiators and/or communication results, and the multi-channel analysis system may use associations between communication sessions and confidence levels to determine and update performance metrics associated with communication initiators and/or communication results.

In an example of the present disclosure, a method includes receiving, by a computer system, a first communication record associated with a first communication channel, the first communication record including first user identification data, and determining, by the computer system, a communication initiator associated with the first communication record. The method also includes receiving, by the computer system, a second communication record associated with a second communication channel different from the first communication channel, the second communication record including second user identification data, and determining, by the computer system, a communication result associated with the second communication record. Additionally, the method includes determining, by the computer system, a confidence level for an association between the first communication record and the second communication record, based at least in part on the first user identification data and the second user identification data, and determining, by the computer system, a performance metric associated with the communication initiator, based at least in part on the confidence level, wherein determining the performance metric comprises recording an association between the communication initiator and the communication result.

In another example of the present disclosure, a computer system comprises one or more processors, and one or more non-transitory computer-readable media storing computer-executable instructions that, when executed by the one or more processors, cause the one or more processors to perform various operations. The operations in this example include determining a communication initiator associated with a first communication session performed via a first communication channel, and determining a communication result associated with a second communication session performed via a second communication channel different from the first communication channel. The operations in this example further include comparing first user identification data associated with the first communication session, and second user identification data associated with the first communication session. Additionally, the operations in this example include, in response to comparing the first user identification data and the second user identification data, updating a performance metric associated with the communication initiator based on the communication result.

Yet another example of the present disclosure includes one or more non-transitory computer-readable media storing instructions executable by a processor, wherein the instructions, when executed, cause the processor to perform various operations. The operations in this example include receiving first data associated with a first communication session performed via a first communication channel, the first data including first user identification data and a communication initiator associated with a first communication session, and receiving second data associated with a second communication session performed via a second communication channel different from the first communication channel, the second data including second user identification data. The operations in this example further include determining a communication result associated with the second communication session, and determining an association between the first communication session and the communication result associated with the second communication session. Additionally, the operations in this example include determining a confidence level for the association between the first communication session and the communication result, based at least in part on the first user identification data and the second user identification data, and determining a performance metric associated with the communication initiator, based at least in part on the confidence level.

### BRIEF DESCRIPTION OF THE DRAWINGS

FIG. 1 is a diagram illustrating an example of related communication records associated with multi-channel communication sessions, in accordance with one or more examples of the present disclosure.

FIG. 2 illustrates an example computing environment including a multi-channel analysis system configured to analyze communication records from multiple communication systems, in accordance with one or more examples of the present disclosure.

FIGS. 3A and 3B illustrate example tables for storing performance metrics associated with communication initiators and communication results, in accordance with one or more examples of the present disclosure.

FIG. 4 is a flow diagram illustrating an example process of analyzing multi-channel communication records and determining performance metrics for communication initiators based on associations between communication records, in accordance with one or more examples of the present disclosure.

FIG. 5 illustrates an example architecture of a computer server capable of executing program components for implementing various techniques described herein.

### DETAILED DESCRIPTION

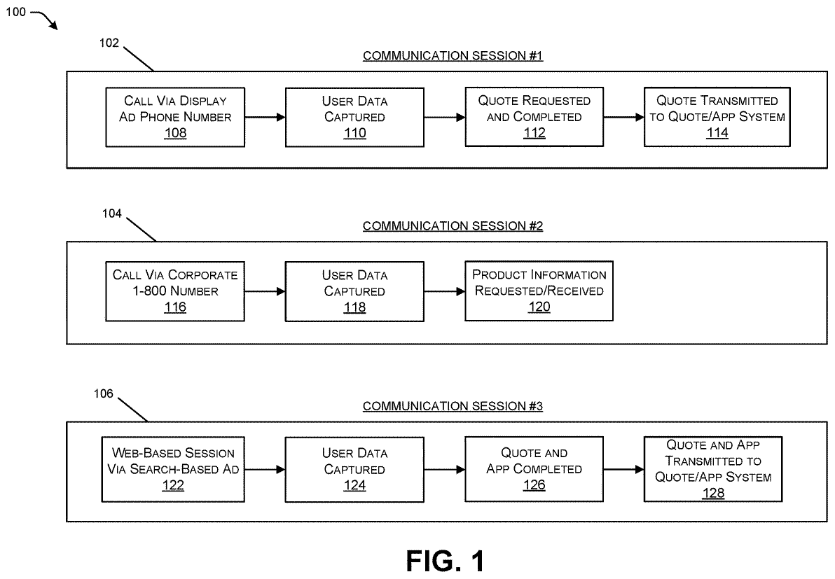

FIG. 1 illustrates an example of a related set of communication sessions 100 processed by one or more multi-channel communication systems. In some examples, a set of related set of communication sessions may be referred herein to as a “customer journey.” For example, the related set of communication sessions 100 may represent a group of separate interactive sessions performed by an individual user or different associated users (e.g., family members, coworkers, etc.) with a number of multi-channel systems of an organization. The related set of communication sessions 100 may lead to one or more communication results, which may include a transaction or sale, a task performed by the organization, or any other measurable outcome of the communication sessions between the user and the organization. As illustrated by the various examples below, the techniques described herein relate to detecting associations between different communication records representing related communication sessions 102-106 between users and an organization. Further techniques described herein include using the associations along with corresponding confidence levels, to evaluate the performance of communication initiators such as marketing efforts associated with the communication sessions, and to improve the efficiency of multi-channel systems in reaching communication results.

In this example, three different communication sessions 102, 104, and 106 are depicted, although it can be understood from the context of this disclosure that any number of communication sessions may be associated in a related group or set of communication records. The communication sessions 102, 104, and 106 in this example represent separate communication sessions related to a customer of an insurance company attempting to obtain a quote and submit an application for an insurance policy. Although FIG. 1 and other examples described here may refer to a multi-channel communication system of an insurance company, other examples of the techniques described herein may be applied similarly to any other industry or technical field in which an organization communicates with uses via multiple different communication channels (e.g., voice, video, chat, web, social media, etc.).

In communication session 102, the customer initiates an interactive voice session with the insurance company at operation 108, by calling a phone number associated with a particular targeted advertisement. For instance, a physical billboard or electronic ad may include a phone number that is associated with a specific marketing effort, rather than a general number associated with the insurance company or an agent. In this example, a user may see the targeted advertisement and call the number to initiate a communication session via a voice communication system (or service) of the insurance company. At operation 110, the organization captures user data associated with the communication session. For instance, the voice communication system may automatically capture the phone number from which the user initiated the call. After routing the call to a quote/acquisition agent specialist in the organization, based on the targeted advertisement, the agent specialist may interact with the user to obtain additional data, such as the user's name, user identifier, account number, physical location (e.g., address), etc. At operation 112, the agent and user discuss insurance policy options, and the user requests and receives a quote for an insurance product, based on the customer-specific data the user has provided. At operation 114, the quote provided to the user is transmitted to a quote/application system of the organization. However, communication session 102 ends without the user deciding to purchase the quoted insurance policy.

Communication session 104 represents another interactive communication session between a user and the organization relating obtaining a quote and purchasing an insurance product. At operation 116, the user, which may be the same user described above or a different user, initiates another interactive voice session with the organization. Instead of calling the same number of the targeted advertisement, in this case the user dials a general phone number for the organization, such as a 1-800 number or a customer service number. At operation 118, the organization captures user data associated with the caller of the voice communication session 104. As in operation 110, in operation 118 the voice communication system may automatically capture the phone number from which the user initiated the call, which may be the same number or a different number. Additionally, the representative agent to which the call is routed may receive some or all of the same user data, such as user's name, phone number, account number, physical address, etc. At operation 120, the user and agent interact and the user requests and receives additional product information, but does not complete another quote, submit an application, or purchase a policy.

Communication session 106 represents another related interactive communication session between a user and the organization. At operation 122 the user initiates a web-based communication session with the organization, for example, by clicking on an electronic advertisement received in response to a web search. At operation 124, the organization captures additional user data via the web-based interactive session. For instance, a web server of the organization may automatically capture a network address or other identifier for the user's device when the web request is received and the connection with the organization server is initiated. Additionally, via a web chat with an agent, or by interacting with web-based forms, the user may provide contact data for an insurance quote including the customer name(s), physical address, etc. In this example, at operation 126, the user once again requests and receives a quote for an insurance product based on the data the user has provided. Additionally, the user in this example completes and submits an application following after receiving and reviewing the quote. At operation 128, the quote provided to the user and the application completed by the user is transmitted to the quote/application system of the organization. In some cases, operation 128 may correspond to an agreement by the user to purchase the insurance product, which may go into effect at the date/time of communication session 106.

As described below in more detail, a multi-channel analysis system may receive communication records corresponding to a set of communication sessions 100, and may determine that the communication sessions 102, 104, and 106 performed over different communication channels are related (or associated). In some examples, the multi-channel analysis system may identify related sets of communication sessions/records by matching various user data captured by the multi-channel communication systems of the organization. For instance, the dialing phone number of communication session 102 may be the same or associated with the dialing phone number of communication session 104, which (along with other attributes of the communication sessions) may cause the multi-channel analysis system to associate communication sessions 102 and 104. Additionally, a physical address input by the user in communication session 102 may match a physical address input by the user in communication session 106, causing the multi-channel analysis system to associate all three communication sessions 102, 104, and 106, and so on.

In the example shown in FIG. 1, the set of communication sessions 100 may be performed via different communication systems (or services) such as an interactive voice system used to perform communication sessions 102 and 104, and a separate interactive web-based system used to perform communication session 106. In other examples, the multi-channel analysis system may receive data from any number of communication systems providing interactive communication services over different communication channels, including voice services, video services, web services, chat/messaging services, customer relationship management (CRM) services, and others. As described below, the various communication systems and services may be implemented as separate and independent systems supporting different communication channels, or may be integrated within a multi-channel contact center environment.

As noted above, a multi-channel analysis system may be configured to determine associated communication sessions by matching user data within the associated communication records. The multi-channel analysis system may match any user data fields available within the communication records, including data captured automatically by the various communication systems (e.g., user device phone number, user device IP address, etc.) and data provided by the user during the communication session. Non-limiting examples of data fields that may be matched by the multi-channel analysis system may include device phone number, device type, device operating system, device name/identifier, device network address, user name, account number, physical address, date of birth, social security number, and/or other personal or device data.

Certain communication sessions and/or records may be associated with communication initiators. As used herein, a “communication initiator” may refer to a direct or indirect cause of a user-initiated interactive communication session with an organization. Examples of communication initiators include marketing efforts and/or campaigns, such as physical ads (e.g., billboards, print ads, etc.), online ads (e.g., embedded clickable ads, paid search-engine results, etc.), physical and electronic mailings, search engine optimization techniques, etc. In some cases, communication initiators may direct a user to contact the organization via a general communication portal, such as a 1-800 number, a home web page, email address, or customer service portal for the organization. In other cases, communication initiators may be associated with a specific marketing effort, such as printed or electronic advertisement including a phone number designated for the particular advertisement, or a clickable electronic link that includes a particular web address or invokes a particular URL associated with the link. When a communication initiator is associated with a specific marketing effort, the communication system that receives the initial user request (e.g., the incoming phone call, web request, etc.) may use the incoming request to identify the particular communication initiator.

As an example, if the communication request received in operation 108 is a call to an incoming phone number that is displayed only in a specific set of advertisements, then the multi-channel analysis system may determine that the communication initiator for the communication session 102 is the set of advertisements. As another example, if the request received in operation 122 is based on the user clicking a particular link embedded in a web page or email, then the multi-channel analysis system may determine that the communication initiator for the communication session 106 is the embedded link. In still other examples, a communication session may not have a communication initiator that can be discerned by the multi-channel analysis system, such as for calls to a main/general organization number, emails to a main/general organization address, web page requests to general organization portal, and the like.

Some communication sessions also may be associated with communication results. As used herein, a “communication result” may refer to any outcome or effect of a communication session between a user and a communication system of the organization that can be detected by the organization. Examples of communication results may include page views/visits, comments, likes, shares, or purchases by the user, and/or any other feedback provided by the user during or after a communication session. For an organization having a customer service and/or technical support department, additional examples of communication results may include opening, updating, or resolving a help ticket. Certain types of communication results may be organization-specific and/or industry-specific. For an insurance company, as an example, additional types of communication results may include the user requesting an insurance quote, an insurance quote being provided to the user, the user submitting an application for an insurance product, the user receiving an approval of an application, and the user purchasing an insurance product.

As noted above, a multi-channel analysis system may identify associations between communication sessions performed and managed by different communication systems over different communication channels (e.g., voice, video, web, chat, social media, in-person, etc.). Therefore, in some examples the multi-channel analysis system may identify new (e.g., previously undetected) associations between communication initiators, communication sessions, and/or communication results. For instance, in the example shown in FIG. 1 the communication session 102 may be associated with a communication initiator (e.g., a targeted marketing campaign), and the communication session 106 may be associated with a communication result (e.g., an insurance purchase or submitted application). By determining that the communication sessions 102, 104, and 106 are related, the multi-channel analysis system also may determine implicitly that communication session 106 and its result of a submitted insurance application are associated with communication session 102 and its initiator of a targeted marketing campaign.

Additionally, the multi-channel analysis system may analyze the communication records and attributes of the associated communication sessions 102, 104, and 106, to analyze the customer journey from a beginning point at operation 108 to an ending point at operation 128. When analyzing a customer journey, the multi-channel analysis system may use the communication records for associated communication sessions 102, 104, and 106 of the journey to determine an overall time, number of interactions, costs (e.g., personnel, computing resources, etc.) and efficiency (e.g., redundant tasks or functions) of the journey.

As described below in more detail, in various examples the associations between communication sessions may be determined based on matching user data and/or various other attributes of the communication sessions, such as communication session time, the organizational unit/department handling the communication session, etc. In some cases, determining a relation or association between communication sessions may include determining a confidence level for the association based on the types and numbers of matching user data fields, and other communication session attributes. When the confidence level for an association between communication sessions meets or exceeds a threshold, the association may be deemed verified and the performance metrics and efficiency analyses for communication initiators, communication results, etc., may include the associated sessions. For example, a numeric performance metric value(s) for a particular communication initiator may be incremented to include the communication result data (e.g., page visits, views, quotes, application, purchases, etc.) for any of the other associated communication sessions. Otherwise, when a confidence level for an association is below a threshold, the performance metrics and/or efficiency analyses may exclude the associated sessions. For instance, the performance metric value(s) for a communication initiator might not be updated based on the communication results of associated communication sessions, if the confidence level for the association between the communication sessions is below a threshold. In some examples, the multi-channel analysis system may apply weights based on the confidence level, so that the performance metric value(s) for a communication initiator are updated partially or fully based on a weight value that depends on the confidence level of the association between the communication sessions.

As an example of performance metrics and/or efficiency analyses, the techniques described herein may relate to evaluating and optimizing customer acquisition costs associated with particular advertisements or advertising channels. Cost per click is another metric based on dividing the cost of an advertisement by people who click, versus the customer acquisition costs of uses individuals who make a purchase. Cost per click is often employed as a measurement by conventional systems in situations when the customer acquisition costs cannot be accurately calculated, and thus systems are unable to track how many people purchase in other channels effectively. Cost per click also may be a less valuable metric, as it measures only the delivering of prospects rather than actual purchasing customers, and may be susceptible to “click farming” or other pay-per click bidding techniques. The techniques described herein improve on these performance metrics by using a more accurate customer acquisition cost metric (e.g., including the true multi-channel customer acquisition costs) and not relying on costs per click as a less accurate proxy.

Attribution is another performance metric that may be used in conventional systems. There are different types of attribution, such as first, last, single touch, multi-touch, etc. In contrast to conventional calculation attributions, the techniques described herein support more accurate attribution by determining more about the actions customers take prior to purchasing, allowing single and multi-touch attribution to be more effective performance measurements. For example, conventional systems attempting to determine single touch attribution based on the first customer action may be in error because they cannot accurately determine the first customer action, and thus may give attribution to the wrong action. In contrast, the techniques described herein provide more accurately linking of customer actions to determine the true first customer action linked to a sale/purchase. Additionally, for multi-touch attribution the techniques here improve link actions of customers across different channels that may could not have been like before, for instance, clicking a web-based ad and calling an agent phone number from a physical billboard, which can determine how many customers did both and in what order, etc.

Additional performance metrics that may be calculated using the techniques described herein include operationally related metrics that may apply to service transactions, claim filings, changing a vehicle on a policy, etc. For example, a time to purchase metric corresponds to how long it takes a potential customer to purchase the product from starting the initial quote until a payment was made. The techniques described herein include surface additional time from multiple quotes across different channels, to determine a more accurate time to purchase metric. Additionally, time to shop metric corresponds to how long it takes to get to a price in the quote, which often involves multiple sessions where the user started and stopped prior to seeing a price. Again, the communication session linking techniques described herein are capable of surfacing additional time from multiple different sessions across different channels, to determine improved time to shop metrics. A number of interactions metric, corresponding to how many different times does a customer or potential customer call, click or email into an organization before completing a task, is another example performance metric that can be improved using the techniques described herein.

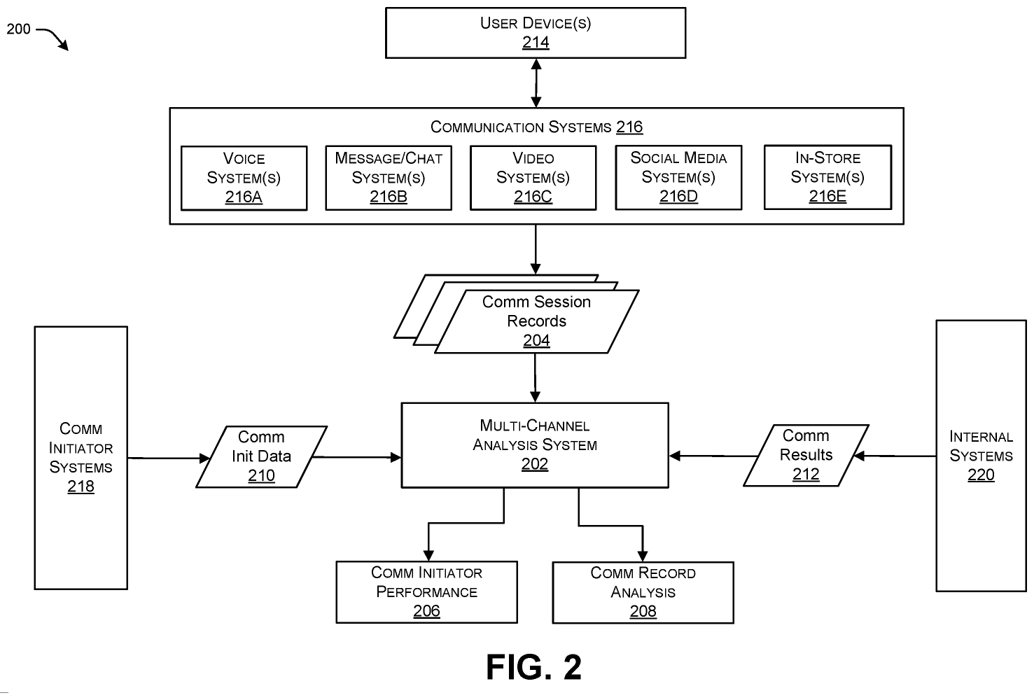

FIG. 2 illustrates an example computing environment 200 including a multi-channel analysis system 202 configured to analyze communication records 204 and determine associations between communication sessions performed over different communication channels. As noted above, the multi-channel analysis system 202 may determine associations between communication sessions by analyzing communication records 204 based on communication sessions, and identifying matching user data fields within the communication records (e.g., phone numbers, physical addresses, names, device identifiers, etc.). Associated communication sessions may be determined based on the number, type, and accuracy of matching data fields, along with various additional attributes of the communication sessions.

After determining a set (or group) of associated communication records 204, the multi-channel analysis system 202 may use the associations to determine performance metrics for communication initiators 206 and/or analyses for the group of communication records 204. For instance, the multi-channel analysis system 202 may receive communication initiator data 210 and communication result data 212. The multi-channel analysis system 202 may use the associations between groups of communication records 204 to determine further associations between communication initiators and communications results. The performance metrics for a communication initiator may be determined based on the communication results associated with (e.g., within the same group of communication records 204) the communication initiator. For instance, if a first communication record 204 is based on a communication initiator, then determining a performance metric for the communication initiator may include evaluating the communication results for any other communication records 204 in the same group (e.g., within the same customer journey) as the first communication record.

The multi-channel analysis system 202 also may use the associations between communication records 204 to analyze groups of related communication sessions occurring over different communication channels. For instance, a group of related communication sessions (e.g., customer journey) may be analyzed in terms of the communication results of the customer journey, with respect to time, number or communication sessions, organizational cost, efficiency, and the like.

As shown in this example, the multi-channel analysis system 202 may receive communication records 204 from a number of communication systems 216. The communication records 204 represent communication sessions between the various communication systems 216 and user devices 214. Communication systems 216A-216E (which may be referred to individual or collectively as communication system(s) 216), may provide functionality for initiating, routing, managing, and logging interactive communications sessions between users and representatives (e.g., employees) of the organization. As shown in this example, each communication systems 216 may implement functionality of providing interactive sessions between customers and representatives over a distinct communication channel. In this example, the organization supports a first voice communication system (or telephony system) 216A, a second messaging/chat communication system 216B, a third video communication system 216C, a fourth social media-based communication system 216D, and a fifth in-store communication system 216E configured to monitor and record in-store user interactions. An organization may use any combination of external or internal communication systems and/or services as communication systems 216. For instance, each of the communication systems 216 may be implemented using internal servers or datacenters of the organization, using on-premise or cloud-based computing infrastructures, or may be provided by external third-party communication service providers. In some examples, some or all of the communication systems 216 may be implemented within a contact center associated with the organization.

User devices 214 may include any personal computing devices, such as desktop or laptop computers, mobile devices (e.g., smartphones, tablet computers, etc.), wearable computing devices, or any other device capable of communicating over communication network(s). In some scenarios, a user (e.g., a customer, client, or other individual associated with the organization) may use a user device 214 to contact the organization via a point-of-contact service, such as web portal(s) or voice gateway. In some examples, the communication systems 216 may support different services for different communication types, such as a web portal that processes web chat requests received via the web site of the organization, a voice gateway that processes calls received via a telephone network and/or Voice over IP (VOIP) calls, etc. Additional customer portals/gateways may be used for voice communications from user devices 214, video communications, messaging/chat communications, social media-based communications, customer relationship management (CRM) based communications, and so on.

Communication initiator data 210 may be received from one or more communication initiator systems 218, which may be internal or external to the organization. The communication initiator systems 218 may provide relevant data for the various communication initiators associated with the organization, such as ad-specific phone numbers, ad-specific URLs or web links, data regarding targeted advertisements, printed or emailed customer mailings, search engine-based advertisements, and the like. Relevant data may include time windows, recipients, and other related content (e.g., search terms) associated with different marketing efforts, or any other information sufficient to allow the multi-channel analysis system 202 to match a particular communication session with a particular marketing effort or other communication initiator.

Communication results data 212 may be received from one or more internal systems 220 associated with the organization, and/or from communication systems 216. As noted above, communication result data may include any outcome or effect of a communication session with a user that can be detected by the organization. Certain communication results such as incoming requests (e.g., calls, clicks, page views, etc.) may be stored and provided by communication systems 216. In contrast, communication results such as resolved help tickets, quotes, applications, purchases, and the like may be stored provided by internal systems 220 of the organization. Internal systems 220 may include, for example, sales system, an account services system, a customer support system, and the like. The number and functionality of the internal systems 220 may depend on the organization type. As an example, for an insurance provider the internal systems 220 may include one or more of a policy sales system, an underwriting system, a fraud detection system, a claims system, a settlement system, etc. Other organizations may implement other types of internal systems 220.

In some examples, individual communication records 204 and/or groups of related communication records 204 may be associated with particular internal systems 220. For instance, if a user selects a menu option of “Sales” during a phone or web-based session, the multi-channel analysis system 202 may determine that the other communication sessions in the same group (e.g., the same customer journey) are associated with an internal sales system. In this example, the multi-channel analysis system 202 may determine associations between sales-related communication initiators and/or sales-relates communication results, and in some cases may exclude communication initiators and results that not associated with the internal sales system of the organization.

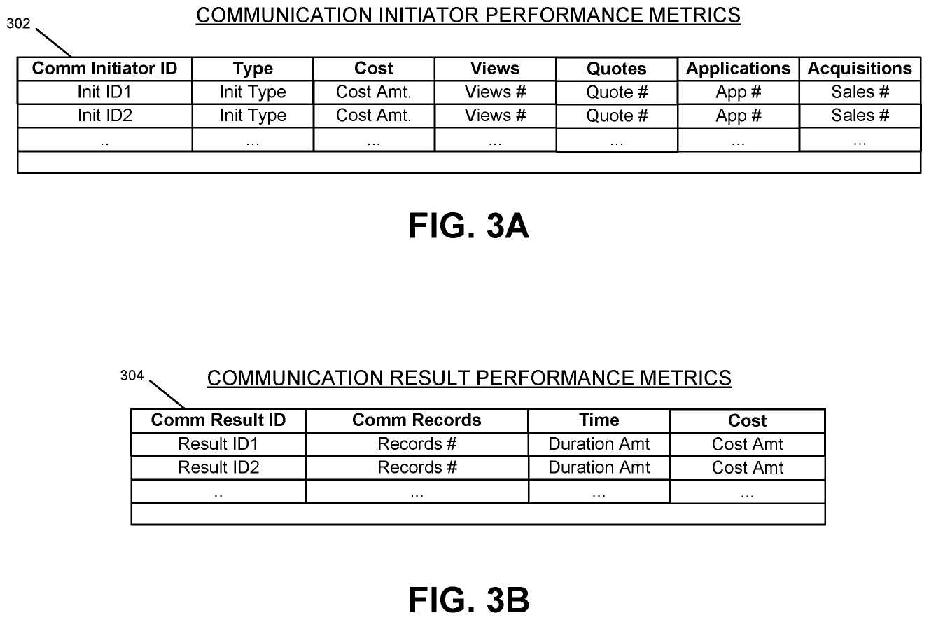

FIGS. 3A and 3B depict two example tables storing performance metrics based on groups of associated multi-channel communication sessions. In this example table 302 includes an example set of performance metrics for communication initiators. As discussed above, the multi-channel analysis system 202 may determine an associated group of communication sessions (corresponding to a customer journey), and then may determine the communication initiator(s) associated with the group. In table 302, an example set of performance metrics is shown for a number of communication initiator(s), including a communication initiator identifier, a type of the communication initiator (e.g., a type of marketing effort), a cost of the communication initiator, a number of views (e.g., clicks or web page views) received based on the communication initiator, a number of quotes provided based on the communication initiator, a number of applications submitted by customers based on the communication initiator, and a number of acquisitions (e.g., policy sales) based on the communication initiator. Although this example includes performance metrics based on the communication results for a policy sales business unit of an insurance company, it can be understood from the context of this disclosure that other types of performance metrics may be used for different business units and/or organization types.

In contrast to table 302, table 304 shows an example set of performance metrics for a number of communication results. To determine the performance metrics for a communication result, the multi-channel analysis system 202 may determine an associated group of communication sessions (corresponding to a customer journey), and then determine communication result(s) associated with the group. In this example, for each communication result, table 304 may include a communication result identifier, a set of associated communication sessions/records, a time duration, and a cost. The communication records field of table 304 may include a number and/or a listing of the communication records associated with the communication result (e.g., the number of communication sessions in the customer journey). The cost field of table 304 may include a cost(s) to organization of reaching the communication result, such as the personnel costs and/or computing resources used by the organization during the customer journey. The time field of table 304 may include a duration of time encompassing the group of communication sessions in the customer journey.

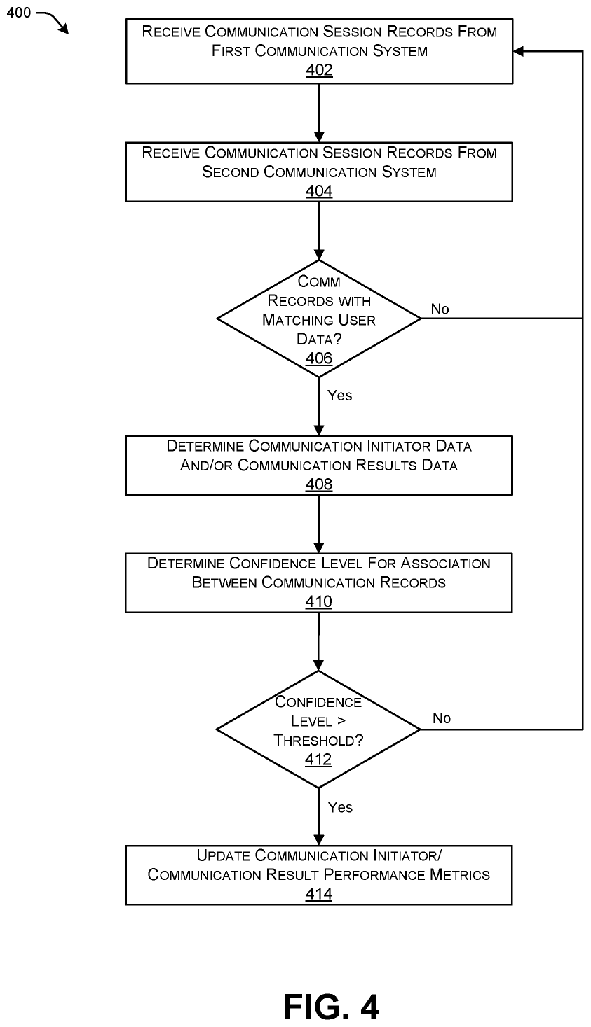

FIG. 4 is a flow diagram illustrating a process 400 of analyzing multi-channel communication records and determining performance metrics for communication initiators and/or communication results, based on associations between communication records. In some examples, process 400 may generate performance metric data such as the data discussed above in table 302 for communication initiators and/or table 304 for communication results. As described below, the techniques and operations of process 400 may be performed by a multi-channel analysis system 202, including or in combination with any of the various components described above in FIGS. 1-3. As described below, in some instances the operations of process 400 may be performed in response to operator input received via an interface.

At operation 402, the multi-channel analysis system 202 may receive communication records 204 from a first communication system 216. In the example, the first communication system may correspond to a communication system or service for a particular communication channel, such as voice channel, video channel, web channel, chat/messaging channel, social media channel, customer relationship management (CRM) channel, etc.).

At operation 404, the multi-channel analysis system 202 may receive additional communication records 204 from a second communication system 216 corresponding to a different communication channel than the first communication system. As an example, a set of communication records 204 received in operation 402 may include voice call records received from a voice communication system 216A, while the communication records 204 received in operation 404 may correspond to web chat records received from a messaging/chat communication system 216B.

At operation 406, the multi-channel analysis system 202 may compare the communication records 204 received in operations 402 and 404, to determine one or more sets of associated communication sessions. As noted above, a customer journey to perform various tasks and/or communication results may include multiple different communications between the user and the organization performed over multiple different communication channels. The multi-channel analysis system 202 may use the various techniques described herein, alone or in combination, to determine associations between communication sessions in operation 406. In some examples, the multi-channel analysis system 202 may match individual user data fields captured by the communication systems 216 and included within the communication records 204. User data fields that may be matched can include phone numbers, physical addresses, email addresses, device identifiers, network addresses, customer names, account numbers, dates of birth, social security numbers, etc.

As noted above, in some cases different communication records 204 may include matching user data fields and/or may be associated with the same customer journey, even when the communication records 204 involve different users and/or different user devices 208. For instance, a first user may initiate a first communication session 102 to perform a task or achieve communication result, and then a second user (e.g., a spouse, family member, coworker, etc.) may initiate a subsequent communication session 106 to continue the same task or result. Additionally or alternatively, the same user or different users may use different user devices 208 to engage in different communication sessions related to the same task or result. For instance, a user's mobile device may be used to perform a first interactive voice communication session 102, and a separate computing device may be used to perform a separate web-based communication session 106. As these examples illustrate, the multi-channel analysis system 202 may determine associations between communication records 204 from different communication channels, based on matching user data fields and/or other attributes of the communication sessions, even when different users or different user devices are used to perform the communication sessions.

The multi-channel analysis system 202 may compare and match specific user data fields and/or other attributes of the communication sessions, to link communication sessions. When performing a comparison, standardization may be applied both within the communication sessions themselves and in the matching logic, prior to the comparison, to standardize fields such as an address, phone number, birthdate, etc. Time differences and time thresholds also may be used when aligning communication sessions, so that different time periods can be used for different measurements. Additionally, in some examples an interactive voice response (IVR) systems may be used to track which options a user selected in within a telephone or web-based customer interaction, and may align those options with the communication session. Additionally, in various implementations the techniques described herein may be used interactively and/or on-demand. For instance, the multi-channel analysis system 202 may examine and classify communications sessions as they are received, and may perform assessments, determinations, and/or performance measurements in real-time based on static data from past communication systems that is stored in the disparate systems.

In this example, if the multi-channel analysis system 202 does not identify any matching data fields within the multi-channel communication records 204 (406: No), then process 400 may be terminated or may return to operation 402 to receive additional data records from additional communication systems 216. In contrast, if the multi-channel analysis system 202 identifies matching data fields in the multi-channel communication records 204 (406: Yes), then process 400 may proceed to operation 408 described below. Instead of or in addition to matching user data fields to determine associated communication records 204, the multi-channel analysis system 202 may compare the times of the communication records 204, and may determine that communication records 204 occurring within a time duration threshold are related/associated communication records. Additionally or alternative, the multi-channel analysis system 202 may determine and compare the internal systems within the organization associated with the communication records, to determine related/associated groups of communication records. Further, although two sets of communication records 204 from two communication systems/channels are shown in this example, it can be understood from the context of this disclosure that the multi-channel analysis system 202 may receive and compare communication records 204 from any number of communication systems 216 and/or any number of different communication channels.

At operation 408, the multi-channel analysis system 202 may determine communication initiator data and/or communication results data for the group(s) of associated/related communication records determined in operation 406. Determining communication initiator(s) for an associated group of communication sessions (e.g., a customer journey) may include analyzing the communication records 204 for the group and the communication initiator data 210, and determining any communication initiator(s) associated with any of the communication records in the group. Similarly, to determine the communication result(s) for an associated group of communication sessions (e.g., a customer journey), the multi-channel analysis system 202 may analyze the communication records 204 for the group and the communication results data 212 to determine any communication results associated with any of the communication records in the group.

At operation 410, the multi-channel analysis system 202 may determine a confidence level associated with an association between communication records 204. As noted above, even when a group of communication records 204 shares one or more user data fields, the communication records 204 might not be associated with the same customer journey and/or same communication result. For instance, multiple communication sessions between a user and the organization may be performed using the same user device 208, and may involve the user providing one or more items of matching user data, but may be related to different customer journeys/communication results. As another example, different users sharing the same phone number, physical address, or account number, etc., may initiate unrelated communication sessions with the organization. Accordingly, in operation 410 the multi-channel analysis system 202 may analyze the group of associated communication records 204 determined in operation 406 to determine a confidence level indicating the likelihood that the group of communication records 204 is related to the same customer journey/communication result.

In various examples, confidence levels may or may not be static. For example, different (e.g., higher or lower) confidence levels may be applied for linking communication sessions, depending on the performance metric(s) for which the linking is being used. For example, when calculating an attribution performance pay amount for a vendor of an online advertisement, a higher confidence level for linking communication sessions may be applied to improve the accuracy and confidence associated with the metric. In contrast, when calculating an average number of interactions prior to completing a process, a lower confidence interval may be applied, thereby allowing additional communication sessions to be linked together for that measure. Similar differences in confidence levels also may be applied to the length of time in-between communication sessions as well. For example, a longer length in time between two communication sessions may result in determine a link/association, but with a lower confidence level for the link between the two sessions.

In various examples, the multi-channel analysis system 202 may compare the number and/or types of matching user data fields to one or more thresholds. For instance, multiple matching fields of user data may increase the confidence level in the determined association of communication records. Additionally, certain types of user-specific data and/or private user (e.g., social security numbers, dates of birth, PIN numbers or passcodes) may be less likely to be shared between users, and thus matches within the user-specific or private user data fields also may increase the confidence level of the determined association. In contrast, associated communication records that only match commonly shared user data fields (e.g., physical address, shared device network address, etc.), may be assigned lower confidence levels. Additionally or alternatively, associated communication records 204 that have relatively close time stamps may be assigned increased confidence levels, while associated sets of communication records 204 that are separated by longer time durations may have reduced confidence levels for the determined association.

At operation 412, the multi-channel analysis system 202 may compare the confidence level determine in operation 410 to one or more confidence thresholds. When the confidence level does not meet a predetermined threshold value (412: No), then process 400 may be terminated or may return to operation 402 to receive additional data records from additional communication systems 216.

When the confidence level determined in operation 410 for an associated group of communication records meets or exceeds the predetermined threshold value (412: Yes), then at operation 414 the multi-channel analysis system 202 may update one or more performance metrics for the communication initiators and/or communication results associated with the group of communication records. For example, a performance metric associated with a communication initiator may be updated based on determining an indirect association with a communication result, or vice versa. For a communication initiator, one or more performance metrics including a number of views/clicks, number of quotes provided, number of applications submitted, number of associated sales, etc., may be updated to include the associated communication result. For a communication result, performance metrics such as the number of communication sessions to reach the result, the time to reach the result, and/or the cost to the organization to reach the result may be updated based on the associated communication records within the customer journey and/or any identified communication initiators.

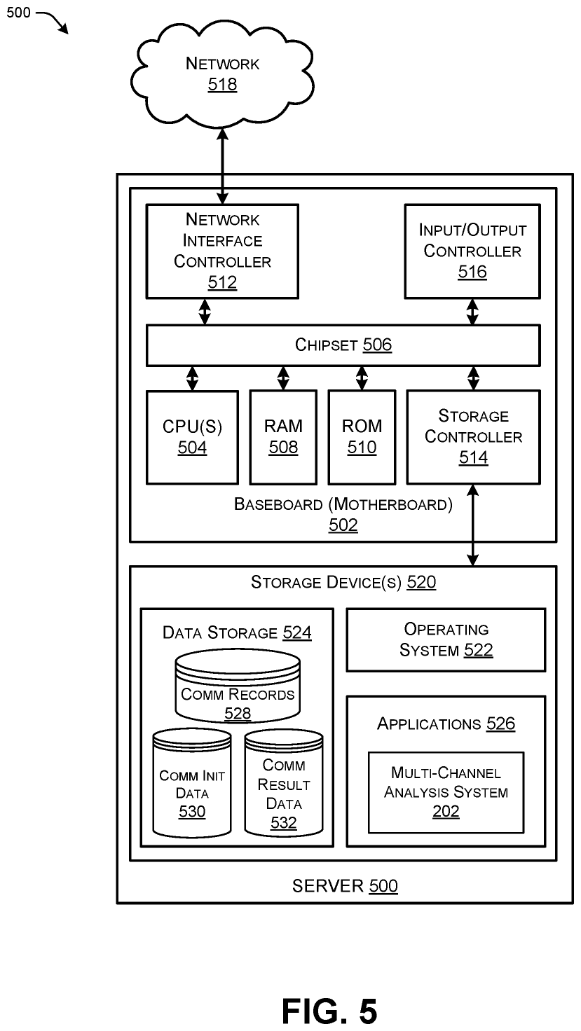

FIG. 5 shows an example architecture of a computer server 500 capable of executing program components for implementing the various functionality described herein. Although the computer architecture in this example is labeled as a server, it can be understood from this disclosure that similar or identical computer architectures may be implemented via workstations, desktop or laptop computers, tablet computers, network appliances, mobile devices (e.g., smartphones, etc.) or other computing device, and/or virtual machines or cloud-based computing solutions, any or all of which may execute any combination of the software components described herein. The server 500 may, in some examples, correspond to any of the computing systems or devices described above, such as the multi-channel analysis system 202, communication system(s) 216, communication initiator systems(s) 218, organization internal system(s) 220, and/or any other computing devices, systems, or components executing the software components described herein. It will be appreciated that in various examples described herein, a server 500 might not include all of the components shown in FIG. 5, may include additional components that are not explicitly shown in FIG. 5, and/or may utilize a different architecture from that shown in FIG. 5.

The server 500 includes a baseboard 502, or “motherboard,” which may be a printed circuit board to which a multitude of components or devices are connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the server 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the server 500. The chipset 506 can further provide an interface to a computer-readable storage medium such as a ROM 510 or non-volatile RAM (“NVRAM”) for storing basic routines that help to startup the server 500 and to transfer information between the various components and devices. The ROM 510 or NVRAM can also store other software components necessary for the operation of the server 500 in accordance with the configurations described herein.

The server 500 can operate in a networked environment using logical connections to remote computing devices and computer systems through a network, such as the network 518, which may be similar or identical to any of the communication networks discussed above. The chipset 506 also may include functionality for providing network connectivity through a Network Interface Controller (NIC) 512, such as a gigabit Ethernet adapter. The NIC 512 is capable of connecting the server 500 to other computing devices (e.g., communication system(s) 216, communication initiator systems(s) 218, organization internal system(s) 220, etc.) over the network 518. It should be appreciated that multiple NICs 512 can be present in the server 500, connecting the computer to other types of networks and remote computer systems. In some instances, the NICs 512 may include at least on ingress port and/or at least one egress port.

The server 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device.

The server 500 can include one or more storage device(s) 520, which may be connected to and/or integrated within the server 500, that provide non-volatile storage for the server 500. The storage device(s) 520 can store an operating system 522, data storage systems 524, and/or applications 526, which are described in more detail herein. The storage device(s) 520 can be connected to the server 500 through a storage controller 514 connected to the chipset 506. The storage device(s) 520 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server 500 can store data on the storage device(s) 520 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device(s) 520 are characterized as primary or secondary storage, and the like.

For example, the server 500 can store information to the storage device(s) 520 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server 500 can further read information from the storage device(s) 520 by detecting the physical states or characteristics of one or more particular locations within the physical storage units.

In addition to the storage device(s) 520 described above, the server 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the server 500. In some examples, the various operations performed by the computing systems described herein (e.g., multi-channel analysis system 202, etc.) may be implemented within a datacenter including one or more servers or devices similar to server 500. For instance, some or all of the operations described herein may be performed by one or more server 500 operating in a networked (e.g., client-server or cloud-based) arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned above, the storage device(s) 520 can store an operating system 522 utilized to control the operation of the server 500. In some examples, the operating system 522 comprises a LINUX operating system. In other examples, the operating system 522 comprises a WINDOWS® SERVER operating system from MICROSOFT Corporation of Redmond, Wash. In further examples, the operating system 522 can comprise a UNIX operating system or one of its variants. It should be appreciated that other operating systems can also be utilized. The storage device(s) 520 can store other system or application programs and data utilized by the server 500.

In various examples, the storage device(s) 520 or other computer-readable storage media is encoded with computer-executable instructions which, when loaded into the server 500, transform the computer from a general-purpose computing system into a special-purpose computer capable of implementing various techniques described herein. These computer-executable instructions transform the server 500 by specifying how the CPUs 504 transition between states, as described above. In some examples, the server 500 may have access to computer-readable storage media storing computer-executable instructions which, when executed by the server 500, perform the various techniques described herein. The server 500 can also include computer-readable storage media having instructions stored thereupon for performing any of the other computer-implemented operations described herein.

As illustrated in FIG. 5, the storage device(s) 520 may store one or more data storage systems 524 configured to store data structures and other data objects. In some examples, data storage systems 524 may include one or more data stores, such as a communication record data store 528 configured to store and analyze communication records 204 received from multi-channel communication systems 216, a communication initiator data store 530 configured to store data relating to communication initiators, and/or a communication result data store 532 configured to store data relating to communication results. Additionally, the software applications 526 stored on the server 500 may include one or more client applications, services, and/or other software components. For example, application(s) 526 may include any combination of the components discussed above in relation to the multi-channel analysis system 202, and/or other software components described above in reference to FIGS. 1-4.

As illustrated by the above examples, the techniques described herein provide technical advantages that improve the performance analyses of communication initiators, such as marketing efforts and campaigns, targeted online ads, physical and electronic mailings, search engine optimization techniques, and the like. By determining associations and corresponding confidence levels between different communication sessions performed over multiple communication channels, these techniques allow for more accurate linking between initiators of certain communication sessions and results of different communication sessions. The linking and corresponding confidence levels can be used to analyze the value and performance of individual communication initiators in terms of measurable results.

The techniques described herein also provide technical advantages of improved efficiency in managing multi-channel communication systems, in order to reduce the time and the number of user interactions required to achieve a desired communication result. For example, multiple related communication sessions can be associated and analyzed as a related group of interactions (e.g., a customer journey) having an end result achieved or task performed by the group of communication sessions. Related groups of communication sessions may be analyzed to identify the attributes of efficient and inefficient groups. Based on the analyses, the communication systems of the organization may be configured to route and customize communication sessions to reduce the amount of time and/or number of user interactions required to reach an end result of the group of communication sessions, which provides a corresponding reduction in the personnel and computing resources required by the organization to manage the communication sessions of the customer's journey.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving, by a computer system, a first communication record associated with a first communication channel, the first communication record including first user identification data;
determining, by the computer system, a communication initiator associated with the first communication record;
receiving, by the computer system, a second communication record associated with a second communication channel different from the first communication channel, the second communication record including second user identification data;
determining, by the computer system, a communication result associated with the second communication record;
determining, by the computer system, a confidence level for an association between the first communication record and the second communication record, based at least in part on the first user identification data and the second user identification data;
determining, by the computer system, a performance metric associated with the communication initiator, based at least in part on the confidence level, wherein determining the performance metric comprises recording an association between the communication initiator and the communication result; and
transmitting, by the computer system, the performance metric to a communication initiator system associated with the communication initiator.

2. The method of claim 1, wherein determining the performance metric associated with the communication initiator comprises at least one of:
updating a set of communication records associated with the communication initiator, to include the second communication record; and
updating a set of transactions associated with the communication initiator, to include a transaction based at least in part on the communication result.

3. The method of claim 1, wherein determining the confidence level for the association between the first communication record and the second communication record comprises:
determining a time difference between a first time associated with the first communication record and a second time associated with the second communication record.

4. The method of claim 1, wherein determining the confidence level for the association between the first communication record and the second communication record comprises:
determining a physical location associated with at least one of the first communication record or the second communication record; and
determining a first user and a second user associated with the physical location.

5. The method of claim 1, wherein:
the first user identification data includes a first user identifier and a first device identifier associated with the first communication record;
the second user identification data includes a second user identifier and a second device identifier associated with the second communication record; and
determining the confidence level for the association between the first communication record and the second communication record comprises:
determining a difference between the first user identifier and the second user identifier; and
determining a difference between the first device identifier and the second device identifier.

6. The method of claim 1, wherein:
the first communication record is received from a telephony system and corresponds to a voice communication session;
the first user identification data includes a phone number stored by the telephony system;
the second communication record is received from a web server and corresponds to a web-based session; and
the second user identification data includes at least one of an email address and a network address stored by the web server.

7. The method of claim 1, further comprising:
routing a communication session associated with the second communication record to a user device, based at least in part on the confidence level for the association between the first communication record and the second communication record.

8. A computer system, comprising:
one or more processors; and
one or more non-transitory computer-readable media storing computer-executable instructions that, when executed by the one or more processors, cause the one or more processors to perform operations comprising:
determining a communication initiator associated with a first communication session performed via a first communication channel;
determining a communication result associated with a second communication session performed via a second communication channel different from the first communication channel;
determining a difference between first user identification data associated with the first communication session, and second user identification data associated with the first communication session; and
updating a performance metric associated with the communication initiator, based at least in part on the communication result and the difference between first user identification data and the second user identification data.

9. The computer system of claim 8, wherein determining the communication initiator associated with the first communication session comprises:
determining a recipient phone number associated with the first communication session; or
determining a web link used to initiate the first communication session.

10. The computer system of claim 8, wherein updating the performance metric associated with the communication initiator comprises at least one of:
updating a set of communication records associated with the communication initiator, to include the second communication session; and
updating a set of transactions associated with the communication initiator, to include a transaction based at least in part on the communication result.

11. The computer system of claim 8, the operations further comprising:
determining a time difference between a first time associated with the first communication session and a second time associated with the second communication session, wherein updating the performance metric associated with the communication initiator is further based on the time difference.

12. The computer system of claim 8, the operations further comprising:
determining a physical location associated with at least one of the first communication session and the second communication session; and
determining a number of users associated with the physical location,
wherein updating the performance metric associated with the communication initiator is further based on the number of users associated with the physical location.

13. The computer system of claim 8, wherein:
the first user identification data includes a first user identifier and a first device identifier associated with the first communication session;
the second user identification data includes a second user identifier and a second device identifier associated with the second communication session; and
determining the difference between the first user identification data and the second user identification data comprises:
determining a difference between the first user identifier and the second user identifier; and
determining a difference between the first device identifier and the second device identifier.

14. The computer system of claim 8, wherein:
the first communication session corresponds to a voice communication session;
the first user identification data includes a phone number stored by a telephony system associated with the voice communication session;
the second communication session corresponds to a web-based session; and
the second user identification data includes at least one of an email address and a network address stored by a web server associated with the web-based session.

15. The computer system of claim 8, the operations further comprising:
routing the second communication session to a user device, based at least in part on determining the difference between the first user identification data and the second user identification data.

16. One or more non-transitory computer-readable media storing instructions executable by a processor, wherein the instructions, when executed by the processor, cause the processor to perform operations comprising:
receiving first data associated with a first communication session performed via a first communication channel, the first data including first user identification data and a communication initiator associated with the first communication session;
receiving second data associated with a second communication session performed via a second communication channel different from the first communication channel, the second data including second user identification data;
determining a communication result associated with the second communication session;
determining an association between the first communication session and the communication result associated with the second communication session;
determining a confidence level for the association between the first communication session and the communication result, based at least in part on the first user identification data and the second user identification data; and
determining a performance metric associated with the communication initiator, based at least in part on the confidence level.

17. The one or more non-transitory computer-readable media of claim 16, wherein determining the performance metric associated with the communication initiator comprises at least one of:
updating a set of communication records associated with the communication initiator, based on the second communication session; and
updating a set of transactions associated with the communication initiator, based on the communication result.

18. The one or more non-transitory computer-readable media of claim 16, wherein the confidence level for the association between the first communication session and the communication result comprises:
determining a time difference between a first time associated with the first communication session and a second time associated with the second communication session.

19. The one or more non-transitory computer-readable media of claim 16, wherein the confidence level for the association between the first communication session and the communication result comprises:
determining a physical location associated with at least one of the first communication session and the second communication session; and
determining a first user and a second user associated with the physical location.

20. The one or more non-transitory computer-readable media of claim 16, wherein:
the first user identification data includes a first user identifier and a first device identifier associated with the first communication session;
the second user identification data includes a second user identifier and a second device identifier associated with the second communication session; and
determining the confidence level for the association between the first communication session and the communication result comprises:
determining a difference between the first user identifier and the second user identifier; and
determining a difference between the first device identifier and the second device identifier.
